(19) United States
(12) Patent Application Publication
(10) Pub. No.: US 2002/0174591 A1
(43) Pub. Date: Nov. 28, 2002

(54) Damage resistant fishing rod

(76) Inventors: Michael A. Lybarger, Broken Arrow, OK (US); Robert A. Terry, Broken Arrow, OK (US); M. Scott Smith, Broken Arrow, OK (US)

Correspondence Address: FELLERS SNIDER BLANKENSHIP, BAILEY & TIPPENS, THE KENNEDY BUILDING, 321 SOUTH BOSTON SUITE 800, TULSA, OK, 74103-3318, US

(21) Appl. No.: 09/865,217

(22) Filed: May 25, 2001

(51) Int. Cl. A01K 87/00

(52) U.S. Cl. 43/18.1

(57) ABSTRACT

A fishing rod comprising an elongate rod having a removably or permanently attached rod tip. The rod tip comprises reinforcing fiber and a bonding resin. The reinforcing fiber comprises at least 10% by weight poly-para-phenylene terephthalamide fiber. The rod preferably further comprises at least one line guide secured to the rod by application of the same type of reinforcing fiber material and a bonding resin.

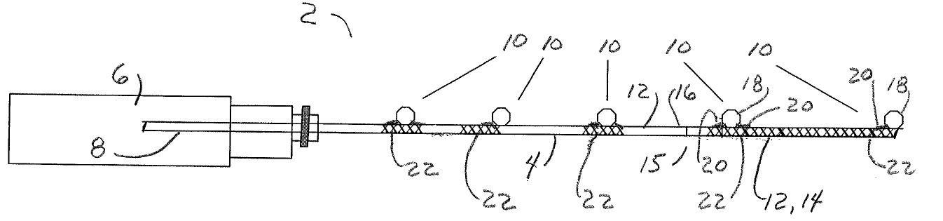

### FIELD OF THE INVENTION

The present invention relates to fishing rods which resist damage when subjected to accidental loads and stresses.

### BACKGROUND OF THE INVENTION

A need exists for fishing rods which are both lightweight and highly durable. A need particularly exists for improved fishing rods which will not break or become permanently damaged when exposed to extreme accidental loadings or deflections. Such loads and deflections can occur, for example, if the end of the rod is shut in a car door, if the end of the rod becomes caught in a tree or bush when carrying, or if the rod becomes caught in or under shifting cargo during transport. When subjected to these types of accidental loads and deflections, the fishing rods heretofore produced in the art typically break or are otherwise permanently damaged at common pinch points located toward the outer end of the rod. Such loads and stresses also commonly cause one or more of the rod line guides to break loose from the rod.

### SUMMARY OF THE INVENTION

The present invention provides a fishing rod which satisfies the needs and alleviates the problems discussed hereinabove. In particular, the present invention provides a novel, cost effective approach for increasing the damage resistance of fishing rods at those points where the rods have been most vulnerable to breakage.

In one aspect, the inventive fishing rod comprises an elongate rod having a distal end segment and a remaining portion comprising at least a second rod segment having a distal end to which the distal end segment is attached. The distal end segment comprises reinforcing fiber material and a bonding resin. The reinforcing fiber material comprises poly-para-phenylene terephthalamide fiber in an amount of at least 10% by weight based on the total weight of the reinforcing fiber material. The remaining portion of the rod has substantially no poly-para-phenylene terephthalamide fiber therein.

In another aspect, the present invention provides a fishing rod comprising an elongate rod having a distal end segment and a remaining portion comprising at least a second rod segment having a distal end to which the distal end segment is removably attachable. The distal end segment comprises reinforcing fiber material and a bonding resin. The reinforcing fiber material comprises poly-para-phenylene terephthalamide fiber in an amount of at least 10% by weight based on the total weight of the reinforcing fiber material. The remaining portion of the rod has substantially no poly-para-phenylene terephthalamide fiber therein.

In yet another aspect, the present invention provides a fishing rod comprising an elongate rod and at least one line guide having a foot portion. The line guide is secured on the elongate rod by applying a fiber reinforcing material over the foot and around the elongate rod. The fiber reinforcing material is bonded with a resin bonding material. The fiber reinforcing material comprises poly-para-phenylene terephthalamide fiber in an amount of at least 10% by weight based on the total weight of the reinforcing fiber material.

The poly-para-phenylene terephthalamide fiber used in the present invention is preferably Kevlar® fiber available from E. I. Du Pont de Nemours. For general fishing uses, the strength, toughness, and abrasion resistance of poly-para-phenylene terephthalamide fiber are at least comparable to those of fiberglass and other common rod fiber materials. However, poly-para-phenylene terephthalamide fiber is about 43% lighter than an equivalent amount of fiberglass. Moreover, poly-para-phenylene terephthalamide fiber material provides a high level of impact strength and damage resistance. Thus, the fishing rods formed in accordance with the present invention are highly resistant to breakage at common pinch points located near the outer end portion of the rod. In addition, the line guide wraps provided by the present invention are also highly resistant to breakage.

Further objects, features, and advantages of the present invention will be apparent to those skilled in the art upon examining the accompanying drawing and upon reading the following description of the preferred embodiments.

### BRIEF DESCRIPTION OF THE DRAWING

The drawing schematically illustrates an embodiment 2 of the fishing rod provided by the present invention.

### DETAILED DESCRIPTION OF THE PREFERRED EMBODIMENTS

An embodiment 2 of the inventive fishing rod is depicted in the drawing. The inventive rod 2 comprises: an elongate rod 4; a handle and grip structure 6 received over or otherwise attached to the proximal end 8 of elongate rod 4; and a plurality of line guides 10 attached to or secured on the top of rod 4. Rod 4 is formed of two or more elongate segments 12 which are either permanently attached or removably attachable to each other.

Of the two or more elongate segments 12 of rod 4, the distal end segment 14 comprises a reinforcing fiber material and a bonding resin. The reinforcing fiber material comprises poly-para-phenylene terephthalamide fiber in an amount of at least 10% by weight based on the total weight of the reinforcing fiber material. The remaining elongate segments 12 of rod 4 preferably contain no poly-para-phenylene terephthalamide fiber but can be formed of generally any conventional rod material including, but not limited to, graphite, fiberglass, aramid fibers other than poly-para-phenylene terephthalamide fiber, and combinations of such materials.

As used herein and in the claims, the terms “distal end segment” and “rod tip” refer to the outermost elongate segment 12 of rod 4. The rod tip 14 can be of any desired length and can be removably or permanently attached at any desired point 15 outside of handle 6.

Rod tip 14 can be removably attachable to the distal end 16 of the adjacent rod segment 12 using ferrules, collars, threads, twist locks, interface fits, or generally any other type of mechanical fittings or couplings known in the art. Such fittings or couplings can be attached to or integrally formed in or on the respective ends of rod segments 12 and 14. Alternatively, rod tip 14 can be permanently attached to the adjacent rod segment 12 by bonding or by a combination of bonding and mechanical attachment. Although generally any type of bonding material could be used in accordance with the present invention, the bonding material described herein for use in attaching line guides 10 to rod 8 is also particularly effective for permanently attaching rod tip 14 to the distal end 16 of the adjacent rod segment 12.

The reinforcing fiber material employed in forming rod tip 14 can be in cloth, ribbon, filament, strand, or generally any other form adaptable to common rod production procedures. Generally any such procedure can be used for producing rod tip 14.

As one example of the use of a conventional technique to produce rod tip 14, multiple plies of resin impregnated cloth can be wrapped around a mandrel to form a hollow rod segment. After curing, the rod segment is removed from the mandrel.

Alternatively, rod tip 14 could be formed by an inventive pultrusion process wherein at least one continuous strand of the reinforcing fiber material is impregnated with the bonding resin and then pulled through a pultrusion die. In a particularly preferred embodiment of this inventive pultrusion process, a plurality of impregnated, continuous strands of the reinforcing fiber material are pulled simultaneously through the pultrusion die.

It will be understood by those skilled in the art that generally any known procedure or technique can be used to form rod tip 14 in any manner necessary to adapt inventive rod 2 for any desired use or type of fish. Thus, inventive fishing rod 2 could be a generic rod, a crappie rod, a spinning rod, a casting rod, a trigger rod, a bass rod, a trout rod, a muskie rod, or generally any other type of rod used in the art. To accommodate these different uses, elongate rod 4 can be formed of any desired number of elongate segments 12. Moreover, rod tip 14 can be of any desired length, can be of any desired cross-sectional shape (e.g., round, hex, etc.), and can be tapered or of constant diameter. Further, as the two production techniques discussed above suggest, rod tip 14 can be of solid construction or hollow.

Generally any type of line guides 10 can be used on inventive fishing rod 2. As will be understood by those skilled in the art, each line guide 10 will typically comprise a line guide loop 18 of circular, hex, octagonal, or other shape having a foot piece 20 which extends from one or both sides thereof. In accordance with the present invention, at least one line guide 10 is preferably secured on elongate rod 4 by applying a wrap material 22 over foot piece 20 and around elongate rod 4.

As with the material used for forming inventive rod tip 14, the wrap material 22 used for attaching line guide 10 will preferably comprise a reinforcing fiber material and a bonding resin. The particular reinforcing fiber material used will preferably comprise poly-para-phenylene terephthalamide fiber in an amount of at least 10% by weight based on the total weight of the reinforcing fiber material. The reinforcing material used for wrapping the line guide 10 can be applied in thread, filament, strand, ribbon, or generally any other desired form.

The inventive line guide attachment technique will preferably be used for attaching at least one line guide 10 to rod tip 14 and will most preferably be used for attaching all of the line guides 10 located on rod tip 14.

In all of the embodiments of applicants' invention discussed hereinabove, generally any type of bonding resin known in the art for producing fishing rods can be used. The bonding resin will preferably be either an epoxy resin, a polyester resin, or an isopolyester resin and will most preferably be an epoxy resin.

The reinforcing fiber material used in the present invention preferably comprises poly-para-phenylene terephthalamide fiber in an amount in the range of from 10% to 100% by weight based on the total weight of the reinforcing fiber material. The poly-para-phenylene terephthalamide fiber material employed in the present invention will most preferably be a Kevlar® fiber material available from E.I. Du Pont de Nemours. The reinforcing fiber material can further comprise one or more additional fiber materials in an amount in the range of from 90% to 0% by weight. Such additional fiber material(s) can generally be any fiber material(s) heretofore used in the art for producing fishing rods. Examples of suitable fiber materials include: fiberglass; graphite; non-Kevlar®-type aramids; boron; and combinations thereof.

In a particularly preferred embodiment of the present invention, the reinforcing fiber material employed will comprise (and will more preferably consist essentially of) from 10 to about 30 parts by weight (pbw) poly-para-phenylene terephthalamide fiber and from 90 to about 70 pbw fiberglass. The reinforcing fiber material employed in the present invention will most preferably comprise or consist essentially of about 20 pbw poly-para-phenylene terephthalamide fiber and about 80 pbw fiberglass. Further, the weight ratio of reinforcing fiber material to bonding resin used in the present invention will preferably be in the range of from about 1:4 to about 3:1, and will more preferably be in the range of from about 1:1 to about 7:3.

Thus, the present invention is well adapted to carry out the objects and attain the ends and advantages mentioned above as well as those inherent therein. While presently preferred embodiments have been described for purposes of this disclosure, numerous changes and modifications will be apparent to those skilled in the art. Such changes and modifications are encompassed within the spirit of this invention as defined by the appended claims.

What is claimed is:

1. A fishing rod comprising an elongate rod having a distal end segment and a remaining portion comprising at least a second rod segment having a distal end to which said distal end segment is attached, wherein:
said distal end segment comprises reinforcing fiber material and a bonding resin;
said reinforcing fiber material comprises poly-para-phenylene terephthalamide fiber in an amount of at least 10% by weight based on the total weight of said reinforcing fiber material; and
except for any poly-para-phenylene terephthalamide fiber used for attaching said distal end segment or any line guides to said remaining portion of said elongate rod, said remaining portion has no poly-para-phenylene terephthalamide fiber therein.

2. The fishing rod of claim 1 further comprising a handle from which said remaining portion of said elongate rod extends.

3. The fishing rod of claim 2 wherein said handle is provided on a proximal end of said second rod segment and said distal end of said second rod segment is located outside of said handle.

4. The fishing rod of claim 1 wherein said distal end segment is removably attached to said second rod segment.

5. The fishing rod of claim 1 wherein said distal end segment consists essentially of said reinforcing fiber material and said bonding resin.

6. The fishing rod of claim 5 wherein said reinforcing fiber material comprises said poly-para-phenylene terephthalamide fiber in an amount in the range of from 10 to about 30 parts by weight (pbw) and further comprises fiberglass in an amount in the range of from 90 to about 70 pbw.

7. The fishing rod of claim 6 wherein said reinforcing fiber material consists essentially of said poly-para-phenylene terephthalamide fiber and said fiberglass.

8. The fishing rod of claim 1 wherein said distal end segment is formed by pultruding at least one continuous strand of said reinforcing fiber material impregnated with said bonding resin.

9. The fishing rod of claim 1 wherein said distal end segment is formed by simultaneously pultruding a plurality of continuous strands of said reinforcing fiber material impregnated with said bonding resin through a pultrusion die.

10. A fishing rod comprising an elongate rod having a distal end segment and a remaining portion comprising at least a second rod segment having a distal end to which said distal end segment is removably attachable, wherein:
said distal end segment comprises reinforcing fiber material and a bonding resin;
said reinforcing fiber material comprises poly-para-phenylene terephthalamide fiber in an amount of at least 10% by weight based on the total weight of said reinforcing fiber material; and
except for any poly-para-phenylene terephthalamide fiber used for securing or forming an attachment structure on said distal end or for attaching any line guides to said remaining portion of said elongate rod, said remaining portion has no poly-para-phenylene terephthalamide fiber therein.

11. The fishing rod of claim 10 further comprising a handle from which said remaining portion of said elongate rod extends.

12. The fishing rod of claim 11 wherein said handle is provided on a proximal end of said second rod segment and said distal end of said second rod segment is located outside of said handle.

13. The fishing rod of claim 10 wherein said distal end segment consists essentially of said reinforcing fiber material and said bonding resin.

14. The fishing rod of claim 13 wherein said reinforcing fiber material comprises said poly-para-phenylene terephthalamide fiber in an amount in the range of from 10 to about 30 parts by weight (pbw) and further comprises fiberglass in an amount in the range of from 90 to about 70 pbw.

15. The fishing rod of claim 14 wherein said reinforcing fiber material consists essentially of said poly-para-phenylene terephthalamide fiber and said fiberglass.

16. The fishing rod of claim 10 wherein said distal end segment is formed by pultruding at least one continuous strand of said reinforcing fiber material impregnated with said bonding resin.

17. The fishing rod of claim 10 wherein said distal end segment is formed by simultaneously pultruding a plurality of continuous strands of said reinforcing fiber material impregnated with said bonding resin through a pultrusion die.

18. The fishing rod of claim 10 wherein said bonding resin is an epoxy resin.

19. A fishing rod comprising:
an elongate rod and
at least one line guide having a foot portion,
wherein said line guide is secured on said elongate rod by applying reinforcing fiber material over said foot and around said elongate rod,
said reinforcing fiber material being bonded with a resin bonding material and
said reinforcing fiber material comprising poly-para-phenylene terephthalamide fiber in an amount of at least 10% by weight based on the total weight of said reinforcing fiber material.

20. The fishing rod of claim 19 wherein said reinforcing fiber material comprises said poly-para-phenylene terephthalamide fiber in an amount in the range of from 10 to about 30 pbw and further comprises fiberglass in an amount in the range of from about 90 to about 70 pbw.
